(19) United States
(12) Patent Application Publication
(10) Pub. No.: US 2026/0080580 A1
(43) Pub. Date: Mar. 19, 2026

(54) IMAGE DATA CONTROL APPARATUS

(71) Applicants: DENSO CORPORATION, Kariya-city (JP); TOYOTA JIDOSHA KABUSHIKI KAISHA, Toyota-shi (JP)

(72) Inventor: Takahiro ISHIKAWA, Kariya-city (JP)

(21) Appl. No.: 19/389,566

(22) Filed: Nov. 14, 2025

Related U.S. Application Data
(63) Continuation of application No. PCT/JP2024/015273, filed on Apr. 17, 2024.

(30) Foreign Application Priority Data
May 17, 2023 (JP) 2023-081591

(51) Int. Cl. G06T 11/00; G06V 10/141; G06V 20/59

(52) U.S. Cl. CPC G06T 11/00; G06V 10/141; G06V 20/59

(57) ABSTRACT

In an image data control apparatus, an image data generator generates image data using external light received thereby. A processing unit is configured to process the image data. A determiner determines whether to request transmission of the image data to the processing unit. A transmitter transmits the image data to the processing unit upon the determiner determining to request transmission of the image data to the processing unit, and transmits alternative image data in place of the image data to the processing unit upon the determiner determining not to request transmission of the image data to the processing unit.

### CROSS-REFERENCE TO RELATED APPLICATION

This present application is a bypass continuation application of currently pending international application No. PCT/JP2024/15273 filed on Apr. 17, 2024 designating the United States of America, the entire disclosure of which is incorporated herein by reference, the international application being based on and claiming the benefit of priority from Japanese Patent Application No. 2023-081591 filed on May 17, 2023, the disclosure of which is incorporated herein by reference.

### TECHNICAL FIELD

The present disclosure relates to image data control apparatuses for controlling transmission of image data.

### BACKGROUND

In-vehicle cameras are increasingly used to capture the interior of a vehicle and to record the captured image data. Protecting the privacy of occupants during such in-cabin imaging is a key requirement. Japanese Patent Application Publication No. 2002-197560, for example, discloses a technology that causes a system to start capturing of images in the cabin of a vehicle when an imaging start signal is output from a manual switch operated by a driver.

Specifically, the technology causes the system not to perform capturing of images in the cabin unless the driver actuates the manual switch, making it possible to prevent unrestricted capturing of images in the cabin and contribute to occupant's privacy protection.

### SUMMARY

The technology disclosed in the patent publication allows an occupant to switch such a system for capturing images in the cabin on or off via manual operation.

Once the system is switched to be an imaging-off mode, returning the system to an imaging-on mode requires various initialization processes for, for example, an imager that generates image data, a bus that transmits the data, and a microprocessor that performs core processing. This therefore may cause an issue that capturing images in the cabin cannot be restarted immediately. As described above, the technology disclosed in the patent publication, which turns off the system to achieve privacy protection, may cause an issue of delaying restarting the system to capture images in the cabin.

Similar issues arise where a system is automatically switched from off to on in response to a trigger event (e.g., sudden acceleration/deceleration or a shock above a threshold) primarily for evidence-preservation purposes. For such a system, faster restarting image-capturing in the cabin of the vehicle is desirable.

The present disclosure provides image data control apparatuses, each of which enables privacy protection without stopping image-data generation.

An exemplary aspect of the present disclosure provides an image data control apparatus. The image data control apparatus includes an image data generator configured to generate image data using external light received thereby, and a processing unit configured to process the image data. The image data control apparatus includes a determiner configured to determine whether to request transmission of the image data to the processing unit, and a transmitter configured to transmit the image data to the processing unit.

The transmitter is configured to transmit the image data to the processing unit upon the determiner determining to request transmission of the image data to the processing unit, and transmit alternative image data in place of the image data to the processing unit upon the determiner determining not to request transmission of the image data to the processing unit.

The image data control apparatus makes it possible to avoid the image data generated by the image data generator from being processed by the processing unit upon the determiner determining not to request transmission of the image data to the processing unit without stopping the image data generator. This therefore prevents excessive processing of the image data, thus ensuring sufficient privacy protection.

### BRIEF DESCRIPTION OF THE DRAWINGS

Other aspects of the present disclosure will become apparent from the following description of embodiments with reference to the accompanying drawings in which:

FIG. 1 is a block diagram schematically illustrating an example configuration of an image data control apparatus according to the first embodiment;

FIG. 2 is a schematic diagram illustrating example conditions for transitioning an operation mode of the image data control apparatus to one of predetermined modes according to the first embodiment;

FIG. 3 is a flowchart schematically illustrating an example of a control routine to be executed by the image data control apparatus of the first embodiment;

FIG. 4 is a block diagram schematically illustrating an example configuration of an image data control apparatus according to the second embodiment;

FIG. 5 is a block diagram schematically illustrating an example configuration of an image data control apparatus according to the third embodiment;

FIG. 6 is a block diagram schematically illustrating an example configuration of an image data control apparatus according to the fourth embodiment;

FIG. 7 is a block diagram schematically illustrating an example configuration of an image data control apparatus according to the fifth embodiment;

FIG. 8 is a block diagram schematically illustrating an example configuration of an image data control apparatus according to the sixth embodiment;

FIG. 9 is a block diagram schematically illustrating an example configuration of an image data control apparatus according to the seventh embodiment; and

FIG. 10 is a schematic diagram illustrating example conditions for transitioning the operation mode of the image data control apparatus to one of predetermined modes according to a modified embodiment.

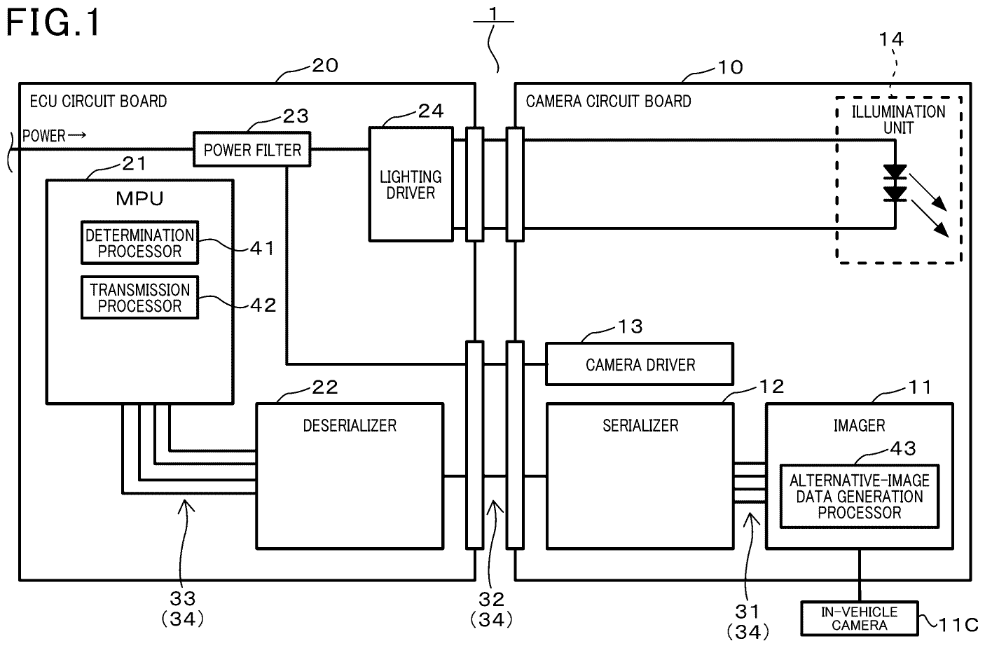

### DETAILED DESCRIPTION OF EMBODIMENTS

### First Embodiment

An image data control apparatus 1 is mounted to a mobile object, such as a vehicle, and includes, for example, two boards 10 and 20.

The board 10 is, for example, a camera circuit board that handles imaging and includes an imager 11, a serializer 12, a camera driver 13, and an illumination unit 14.

The board 20 is, for example, an Electronic Control Unit (ECU) circuit board that provides overall control of the image data control apparatus 1 and includes a Micro Processing Unit (MPU) 21, a deserializer 22, a power filter 23, and a lighting driver 24. The board 10 may be another functional board different from the camera board, and the ECU circuit board 20 may be another functional board different from the ECU circuit board.

The imager 11, which serves as an example of an image data generator, generates image data using external light received thereby. The imager 11 is comprised of mainly a camera sensor. The imager 11 is configured to cooperate with an in-vehicle camera 11C mounted to the vehicle to generate image data based on received external light. Specifically, the in-vehicle camera 11C is positioned to image the vehicle cabin. The imager 11C, which cooperate with the in-vehicle camera 11C, is capable of generating image data reflecting the condition in the vehicle cabin. The imager 11 transmits the generated image data, which is also referred to as parallel image data, to the serializer 12 via buses 31.

The serializer 12, serves as a part of a converter, converts the parallel image data, i.e., the parallel image-data items, to serial image data, i.e., serial image-data items, and transmits the serial image data via a bus 32 to the deserializer 22.

The illumination unit 14, which serves as an example of a light emitting unit, includes, for example, an LED that primarily emits near-infrared light and emits a small quantity of visible light such that a user can visually confirm when the illumination unit 14 emits light. The illumination unit 14 is configured to increase the light quantity to be received by the in-vehicle camera 11C.

The MPU 21, which serves an example of a processing unit, is configured to process image data transmitted from the imager 11 and is configured to perform known various operations such as an operation of recognizing the image data, an operation of storing therein the image data, an operation of transmitting the image data to the outside thereof, and an operation of analyzing the image data.

The deserializer 22 converts the received serial image data into the parallel image data and transmits the parallel image data to the MPU 21 via buses 33. The buses 31-33 together provide at least one transmission path 34 from the imager 11 to the MPU 21. The image data control apparatus 1 is configured such that, within each board 10, 20, data are conveyed in parallel; between the boards and 20, data are conveyed in serial form.

The power filter 23 removes noise on a power supply line through which power is supplied to the image data control apparatus 1. The lighting driver 24 controls power supply to the illumination unit 14, and also controls operations of the illumination unit 14.

The MPU 21 executes an image-data control program stored therein to accordingly implement, in software, a determination processor 41 and a transmission processor 42. These processors 41 and 42 may alternatively be implemented in hardware or hardware-software combination.

The determination processor 41, which servers as an example of a determiner, determines whether to request transmission of image data to the MPU 21.

The transmission processor 42, which serves as an example of a transmitter, transmits, to the imager 11 via the at least one transmission path 34, an image-data transmission command that instructs the imager 11 to transmit the generated image data to the MPU 21 when the determination processor 41 determines to request transmission of image data to the MPU 21. Additionally, the transmission processor 42 transmits, to the imager 11, an alternative image transmission command that instructs the imager 11 to transmit alternative image data in place of the generated image data to the MPU 21. Image data generated by the imager 11 is also be referred to as original image data.

The image data control apparatus 1 further includes an alternative image data generation processor 43 for generating the alternative image data. The alternative image data generation processor 43 according to the first embodiment is implemented as hardware in a portion of the imager 11. The alternative image data generation processor 43 may be implemented as software or a combination of hardware and software in the imager 11.

The alternative image data generation processor 43 may generate, as the alternative image data, full-black image data consisting of zero-value pixels, predetermined solid-color image data consisting of pixels of a predetermined color, predetermined patterned image data consisting of pixels of a predetermined pattern, such as vertical stripes and/or horizontal stripes, or test-pattern image data consisting of pixels of a predetermined test pattern used for testing various devices. That is, the alternative image data generation processor 43 is configured to generate, as the alternative image data, any image data that is different from original image data reflecting the condition in the vehicle cabin.

When receiving the image-data transmission command, the imager 11 is configured to directly transmit generated original image data to the MPU 21 without generating alternative image data through the alternative image data generation processor 43. When receiving the image-data transmission command, the imager 11 may be configured to generate, through the alternative image data generation processor 43, alternative image data and directly transmit generated original image data to the MPU 21 without transmitting the generated alternative image data to the MPU 21.

In contrast, when receiving the alternative image transmission command, the imager 11 is configured to generate alternative image data through the alternative image data generation processor 43 and directly transmit, to the MPU 21, the generated alternative image data. Upon receipt of the alternative image transmission command, the imager 11 is configured to continue generation of original image data without transmitting the generated original image data to the MPU 21.

The illumination unit 14 is configured to emit light in response to the determination processor 41 determining to request transmission of original image data to the MPU 21, and configured not to emit light in response to the determination processor 41 determining not to request transmission of original image data generated thereby to the MPU 21.

In more detail, the MPU 21 is configured to transmit, to the illumination driver 24, an emission start command through an unillustrated transmission path in response to the determination processor 41 determining to request transmission of original image data to the MPU 21. The emission start command instructs the illumination unit 14 to perform an operation of emitting light. When receiving the emission start command, the illumination driver 24 instructs the illumination unit 14 to start the operation of emitting light.

In contrast, the MPU 21 is configured to transmit, to the illumination driver 24, an emission stop command through the unillustrated transmission path in response to the determination processor 41 determining not to request transmission of original image data to the MPU 21. The emission stop command instructs the illumination unit 14 to stop the operation of emitting light. When receiving the emission stop command, the illumination driver 24 instructs the illumination unit 14 to stop the operation of emitting light.

The image data control apparatus 1 includes a camera imaging function and an alarm issuing function. The camera imaging function is implemented by cooperation of the in-vehicle camera 11C, the imager 11, the serializer 12, the deserializer 22, and the MPU 21.

The camera imaging function of the image data control apparatus 1 has three selectable states:
1. A standard-on state, in which original image data generated by the imager 11 is transmitted to the MPU 21.
2. A substitute-on state, in which alternative image data generated by the alternative image data generation processor 43 is transmitted to the MPU 21 instead of the original image data generated by the imager 11.
3. An off state, in which neither original image data nor alternative image data is transmitted to the MPU 21.

The alarm issuing function issues predetermined alarms when at least one of predefined driver unsuitability conditions or driving incapacity conditions is detected by the camera imaging function; the predefined driver-impaired or driver-incapable states. Examples of the driving unsuitability conditions include the driver being distracted (e.g., looking away), the driver's eyes being closed, and the driver exhibiting drowsiness. Examples of the driving incapacity conditions include the driver exhibiting posture collapse due to acute medical conditions such as myocardial infarction or stroke, or the driver being recognized as motionless or rigid.

The alarm issuing function may be implemented using optical, auditory, haptic, and/or olfactory means.

The alarm issuing function using optical means can be implemented, for example, through light emission by the illumination unit 14, display on a meter (not shown), or screen display via an unillustrated navigation device.

The alarm issuing function using auditory means can be implemented, for example, through sound output by an audio output device such as unillustrated speakers.

The alarm issuing function using haptic means can be implemented, for example, through vibration of the seat or steering wheel by an unillustrated vibrating device, force feedback detected by an unillustrated force sensor, air blowing from an unillustrated air conditioner fan, or air blowing by automatically opening the vehicle's windows.

The alarm issuing function using olfactory means can be implemented, for example, through the delivery of a scent by an unillustrated air conditioner fan.

That is, the alarm issuing function may be implemented by at least one of the optical, auditory, haptic, or olfactory means, or by combining two or more of these means.

The vehicle in which the image data control apparatus 1 is installed may include an unillustrated DMS-OFF indicator that shows whether a driver monitoring system (DMS) implemented by the image data control apparatus 1 has been switched off by user intent. The DMS-OFF indicator being switched to be in a display state shows that the DMS is switched off.

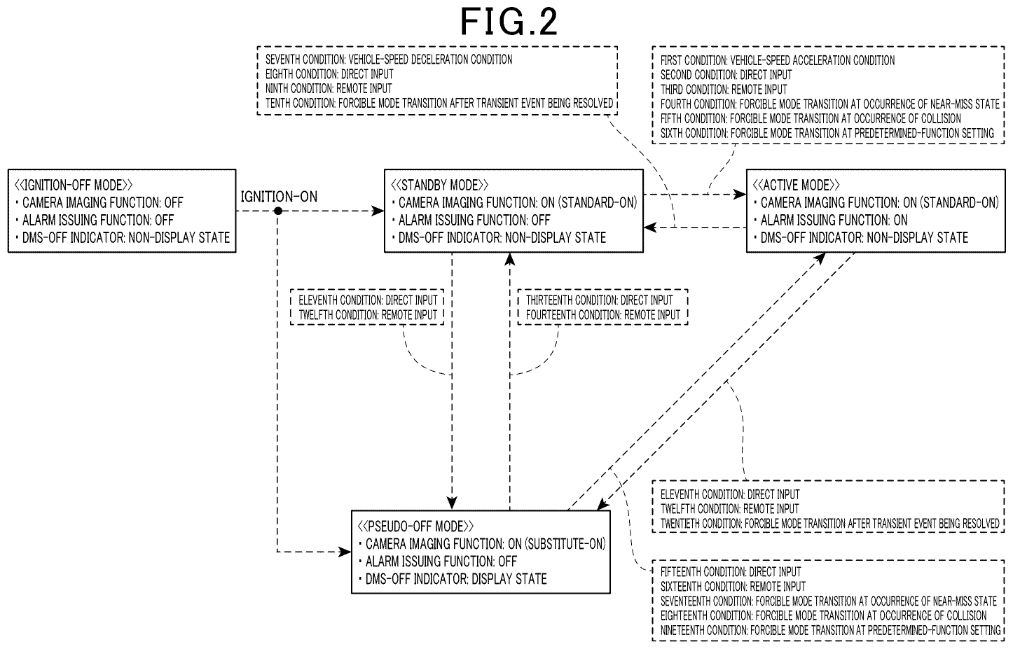

The image data control apparatus 1 is configured to operate selectively in one of multiple modes as the operation mode thereof, which include, as illustrated by way of example in FIG. 2, an ignition-off mode, a standby mode, an active mode, and a pseudo-off mode.

When the image data control apparatus 1 operating in the ignition-off mode, the camera imaging function is set to be in the off state, the alarm issuing function is set to be in the off state, and the DMS-OFF indicator is set to be in a non-display state.

Upon the ignition switch of the vehicle being switched on, the image data control apparatus 1 is configured to transition from the ignition-off mode to any one of the standby mode or pseudo-off mode as a default operation mode. The default operation mode in response to the ignition switch being turned on may be for example set with the permission of the user of the vehicle, such as during the initial setup at a dealership. Alternatively, the image data control apparatus 1 may be configured to store the current operation mode upon exiting the vehicle, that is, upon the ignition switch being switched from on to off, and set the operation mode to the stored operation mode upon entering the vehicle next in response to determination that the stored operation mode is the standby mode or the pseudo-off mode.

It may be preferable to set the default operation mode to the standby mode if the image data control apparatus 1 is configured to permit the driver monitoring system to operate in response to turn-on of the ignition switch. Otherwise, if the image data control apparatus 1 is configured not to permit the driver monitoring system to operate in response to turn-on of the ignition switch, it may be preferable to set the default operation mode to the pseudo-off mode.

The default operation mode may, for example, be set through an unillustrated navigation device. In this case, a notice for setting the default operation mode may be displayed on the screen of the navigation device, and the setting may be performed in response to the driver's pressing of an approval button displayed on the screen. Alternatively, the default operation mode may be set in any other suitable manner.

In the standby mode, the camera imaging function is set to be in the standard-on state, the alarm issuing function is set to be in the off state, and the DMS-OFF indicator is set to be in the non-display state. Because the camera imaging function is set to be in the standard-on state in the standby mode, original image data generated by the imager 11 is directly transmitted to the MPU 21 and light is continuously emitted from the illumination unit 14. The standby mode therefore enables original image data to be generated by the imager 11 while the imager 11 receives a sufficient quantity of light, and the generated original image data to be transmitted to the MPU 21, resulting in the original image data being processed by the MPU 21. Because the alarm issuing function is set to be in the off state, even if the MPU 21 detects at least one of predefined driver unsuitability conditions or driving incapacity conditions, no alarm is issued.

In the active mode, the camera imaging function is set to be in the standard-on state, the alarm issuing function is set to be in the on state, and the DMS-OFF indicator is set to be in the non-display state. Because the camera imaging function is set to be in the standard-on state in the active mode, original image data generated by the imager 11 is directly transmitted to the MPU 21 and light is continuously emitted from the illumination unit 14. The active mode enables original image data to be generated by the imager 11 while the imager 11 receives a sufficient quantity of light and the generated original image data to be transmitted to the MPU 21, resulting in the original image data being processed by the MPU 21. Because the alarm issuing function is set to be in the on state, if the MPU 21 detects at least one of predefined driver unsuitability conditions or driving incapacity conditions, a predetermined alarm is issued.

In the pseudo-off mode, the camera imaging function is set to be in the substitute-on state, the alarm issuing function is set to be in the off state, and the DMS-OFF indicator is set to be in the display state. Because the camera imaging function is set to be in the substitute-on state in the pseudo-off mode, alternative image data generated by the alternative image data generation processor 43 is transmitted to the MPU 21 and emission of light from the illumination unit 14 is stopped. The pseudo-off mode enables the imager 11 to be in the continuously on state, i.e., the imager 11 to continuously execute image-date generation operation, while the alternative image data is transmitted to the MPU 21 in place of original image data, i.e., actual in-cabin image data.

This prevents in-cabin image data generated by the imager 11 from being processed by the MPU 21. The DMS-OFF indicator set to be in the display mode enables the driver monitoring system implemented by the image data control apparatus 1 to be in the off state by driver intent.

The image data control apparatus 1 is configured not to issue an alarm in each of the standby mode and the pseudo-off mode. Although it is apparently difficult to distinguish which of the standby mode and the pseudo-off mode the image data control apparatus 1 operates in, the image data control apparatus 1 is configured to set the DMS-OFF indicator to be in the non-display state in the standby mode and to be in the display state in the pseud-off mode. This configuration therefore makes it possible to easily distinguish, based on the display/non-display state of the DMS-OFF indicator, which of the standby mode and the pseudo-off mode the image data control apparatus 1 operates in.

The image data control apparatus 1 is configured to transition the operation mode from the standby mode to the active mode in response to determination that at least one of the following first, second, third, fourth, fifth, and sixth conditions is satisfied:

The first condition, which is also defined as a vehicle-speed acceleration condition, is that the speed of the vehicle equipped with the image data control apparatus 1 is accelerated to be higher than or equal to a predetermined speed. The image data control apparatus 1 is configured to transition the operation mode from the standby mode to the active mode in response to determination that the first condition is satisfied.

The first condition is an example of a condition under which the image data control apparatus 1 forcibly or automatically performs switching of the operation mode from the standby mode to the active mode.

The second condition is, for example, a condition in which the driver or one or more occupants of the vehicle directly inputs, to the image data control apparatus 1, an instruction for switching the operation mode of the image data control apparatus 1 from the standby mode to the active mode. In response to determination that the second condition is satisfied, the image data control apparatus 1 transitions the operation mode from the standby mode to the active mode. The second condition is an example of a condition for performing human-initiated switching from the standby mode to the active mode.

Specifically, the image data control apparatus 1 includes an operation unit (not shown) configured to be manually operatable by the driver or the one or more occupants of the vehicle. A driver's or an occupant's operation of the operation unit enables the driver or the one or more occupants to input, to the apparatus 1, various instructions, such as an instruction to switch the operation mode of the apparatus 1 from the standby mode to the active mode.

The third condition is, for example, a condition in which a fleet manager that manages operation of multiple vehicles including the vehicle equipped with the image data control apparatus 1 remotely inputs, to the image data control apparatus 1, an instruction for switching the operation mode of the image data control apparatus 1 from the standby mode to the active mode. In response to determination that the third condition is satisfied, the image data control apparatus 1 transitions the operation mode from the standby mode to the active mode. The third condition is an example of a condition for performing human-initiated switching from the standby mode to the active mode.

Specifically, the image data control apparatus 1 includes a receiving unit (not shown) configured to receive various signals transmitted from a terminal operated by the fleet operator. Various operation information items input by the fleet operator's operation of the terminal, such as operation information instructing switching of the operation mode from the standby mode to the active mode, are received by the receiving unit of the image data control apparatus 1. The image data control apparatus 1 is capable of executing the operation-mode transition operation based on the received operation information.

The fourth condition is, for example, a condition in which a predetermined near-miss state has occurred. When the fourth condition is satisfied, the image data control apparatus 1 transitions the operation mode from the standby mode to the active mode.

The predetermined near-miss state includes, for example at least one of: (i) a state in which an abrupt change has occurred in vehicle operation or behavior such as sudden start, sudden stop, or sudden steering; (ii) a state in which an abrupt change has occurred in a measured value of an accelerometer of the vehicle; (iii) a state in which an abrupt change has occurred in measured values of various devices that monitor the surroundings of the vehicle; and (iv) a state in which an object rapidly approaching the vehicle has been detected. The devices that monitor the surroundings of the vehicle include, for example, known in-vehicle cameras, laser devices, radar devices, and proximity sensors. The fourth condition is an example of a condition under which the image data control apparatus 1 forcibly or automatically performs switching of the operation mode from the standby mode to the active mode.

The fifth condition is, for example, a condition in which a collision against the vehicle has occurred. When the fifth condition is satisfied, the image data control apparatus 1 transitions the operation mode from the standby mode to the active mode. It is possible to determine whether the vehicle has impacted due to a collision in response to determination as to whether, for example, an abrupt change in a measured value of the accelerometer of the vehicle has occurred or an impact greater than or equal to a predetermined strength has been measured by an impact sensor of the vehicle. The fifth condition is also an example of a condition under which the image data control apparatus 1 forcibly or automatically performs switching of the operation mode from the standby mode to the active mode.

The sixth condition is, for example, a condition in which a predetermined setting has been made for at least one of predetermined functions installed in the vehicle. When the sixth condition is satisfied, the image data control apparatus 1 transitions the operation mode from the standby mode to the active mode.

The predetermined functions installed in the vehicle include, for example, an advanced driving assistance (ADAS) function. The predetermined setting for the ADAS function includes, for example, a setting of Level 2 autonomous driving (driver-primary automated driving), or a setting of Level 3 autonomous driving (computer-primary automated driving). The sixth condition is also an example of a condition under which the image data control apparatus 1 forcibly or automatically performs switching of the operation mode from the standby mode to the active mode.

Note that the sixth condition may be configured to include human-initiated switching of the operation mode from the standby mode to the active mode in response to direct operation by the driver or the one or more occupants, or to remote operation by the fleet operator. The sixth condition may be configured to encompass both cases: human-initiated mode switching and forced or automatic mode switching by the image data control apparatus 1.

Switching from the active mode to the standby mode can be performed based on satisfaction of at least one of predetermined conditions, namely a seventh condition, an eighth condition, a ninth condition, and a tenth condition.

The image data control apparatus 1 is configured to transition the operation mode from the active mode to the standby mode in response to determination that at least one of the following seventh, eighth, ninth, and tenth conditions is satisfied:

The seventh condition, which is also defined as a vehicle-speed deceleration condition, is that the speed of the vehicle equipped with the image data control apparatus 1 is decelerated to be lower than or equal to a predetermined speed. The image data control apparatus 1 is configured to transition the operation mode from the active mode to the standby mode in response to determination that the seventh condition is satisfied.

The seventh condition is an example of a condition under which the image data control apparatus 1 forcibly or automatically performs switching of the operation mode from the active mode to the standby mode.

The eighth condition is, for example, a condition in which the driver or the one or more occupants of the vehicle directly inputs, to the image data control apparatus 1, an instruction for switching the operation mode of the image data control apparatus 1 from the active mode to the standby mode. In response to determination that the eighth condition is satisfied, the image data control apparatus 1 transitions the operation mode from the active mode to the standby mode. The eighth condition is an example of a condition for performing human-initiated switching from the active mode to the standby mode. A driver's or an occupant's operation of the operation unit enables the driver or the one or more occupants to input, to the apparatus 1, an instruction to switch the operation mode of the apparatus 1 from the active mode to the standby mode.

The ninth condition is, for example, a condition in which the fleet manager that manages operation of the multiple vehicles including the vehicle equipped with the image data control apparatus 1 remotely inputs, to the image data control apparatus 1, an instruction for switching the operation mode of the image data control apparatus 1 from the active mode to the standby mode. In response to determination that the ninth condition is satisfied, the image data control apparatus 1 transitions the operation mode from the active mode to the standby mode. The ninth condition is an example of a condition for performing human-initiated switching from the active mode to the standby mode. The operation information instructing switching of the operation mode from the active mode to the standby mode may be received by the receiving unit of the image data control apparatus 1.

The tenth condition is a condition that a predetermined time has elapsed in a case where the operation mode has been forcibly or automatically transitioned from the standby mode to the active mode based on satisfaction of at least one of the above-described fourth and fifth conditions. When the tenth condition is satisfied, the image data control apparatus 1 transitions the operation mode from the active mode to the standby mode. The tenth condition is an example of a condition under which the image data control apparatus 1 forcibly or automatically performs switching of the operation mode from the active mode to the standby mode.

Occurrence of a near-miss state or occurrence of a collision against the vehicle is merely a transient event that is likely to be resolved after lapse of a certain period. The tenth condition therefore enables, when the operation mode has been switched from the standby mode to the active mode in response to occurrence of a near-miss state or a collision against the vehicle, the operation mode to be automatically returned from the active mode to the standby mode after the lapse of the predetermined time. This prevents continuation of the active mode even though the transient near-miss or collision state has already been resolved.

Switching from the standby mode or the active mode to the pseudo-off mode can be performed based on satisfaction of at least one of predetermined conditions, namely an eleventh condition and a twelfth condition.

The eleventh condition is, for example, a condition in which the driver or the one or more occupants of the vehicle directly inputs, to the image data control apparatus 1, an instruction for switching the operation mode of the image data control apparatus 1 from the standby mode or the active mode to the pseudo-off mode. In response to determination that the eleventh condition is satisfied, the image data control apparatus 1 transitions the operation mode from the standby mode or the active mode to the pseudo-off mode. The eleventh condition is an example of a condition for performing human-initiated switching from the standby mode or the active mode to the pseudo-off mode. A driver's or an occupant's operation of the operation unit enables the driver or the one or more occupants to input, to the apparatus 1, an instruction to switch the operation mode of the apparatus 1 from the standby mode or the active mode to the pseudo-off mode.

The twelfth condition is, for example, a condition in which the fleet manager that manages operation of the multiple vehicles including the vehicle equipped with the image data control apparatus 1 remotely inputs, to the image data control apparatus 1, an instruction for switching the operation mode of the image data control apparatus 1 from the standby mode or the active mode to the pseudo-off mode. In response to determination that the twelfth condition is satisfied, the image data control apparatus 1 transitions the operation mode from the standby mode or the active mode to the pseudo-off mode. The twelfth condition is an example of a condition for performing human-initiated switching from the standby mode or the active mode to the pseudo-off mode. The operation information instructing switching of the operation mode from the standby mode or the active mode to the pseudo-off mode may be received by the receiving unit of the image data control apparatus 1.

Switching from the pseudo-off mode to the standby mode can be performed based on satisfaction of at least one of predetermined conditions, namely a thirteenth condition and a fourteenth condition.

The thirteenth condition is, for example, a condition in which the driver or the one or more occupants of the vehicle directly inputs, to the image data control apparatus 1, an instruction for switching the operation mode of the image data control apparatus 1 from the pseudo-off mode to the standby mode. In response to determination that the thirteenth condition is satisfied, the image data control apparatus 1 transitions the operation mode from the pseudo-off mode to the standby mode. The thirteenth condition is an example of a condition for performing human-initiated switching from the pseudo-off mode to the standby mode. A driver's or an occupant's operation of the operation unit enables the driver or the one or more occupants to input, to the apparatus 1, an instruction to switch the operation mode of the apparatus 1 from the pseudo-off mode to the standby mode.

The fourteenth condition is, for example, a condition in which the fleet manager that manages operation of the multiple vehicles including the vehicle equipped with the image data control apparatus 1 remotely inputs, to the image data control apparatus 1, an instruction for switching the operation mode of the image data control apparatus 1 from the pseudo-off mode to the standby mode. In response to determination that the fourteenth condition is satisfied, the image data control apparatus 1 transitions the operation mode from the pseudo-off mode to the standby mode. The fourteenth condition is an example of a condition for performing human-initiated switching from the pseudo-off mode to the standby mode. The operation information instructing switching of the operation mode from the pseudo-off mode to the standby mode may be received by the receiving unit of the image data control apparatus 1.

Switching from the pseudo-off mode to the active mode can be performed based on satisfaction of at least one of predetermined conditions, namely a fifteenth condition, a sixteenth condition, a seventeenth condition, an eighteenth condition, and a nineteenth condition.

The fifteenth condition is, for example, a condition in which the driver or the one or more occupants of the vehicle directly inputs, to the image data control apparatus 1, an instruction for switching the operation mode of the image data control apparatus 1 from the pseudo-off mode to the active mode. In response to determination that the fifteenth condition is satisfied, the image data control apparatus 1 transitions the operation mode from the pseudo-off mode to the active mode. The fifteenth condition is an example of a condition for performing human-initiated switching from the pseudo-off mode to the active mode. A driver's or an occupant's operation of the operation unit enables the driver or the one or more occupants to input, to the apparatus 1, an instruction to switch the operation mode of the apparatus 1 from the pseudo-off mode to the active mode.

The sixteenth condition is, for example, a condition in which the fleet manager that manages operation of the multiple vehicles including the vehicle equipped with the image data control apparatus 1 remotely inputs, to the image data control apparatus 1, an instruction for switching the operation mode of the image data control apparatus 1 from the pseudo-off mode to the active mode. In response to determination that the sixteenth condition is satisfied, the image data control apparatus 1 transitions the operation mode from the pseudo-off mode to the active mode. The sixteenth condition is an example of a condition for performing human-initiated switching from the pseudo-off mode to the active mode. The operation information instructing switching of the operation mode from the pseudo-off mode to the active mode may be received by the receiving unit of the image data control apparatus 1.

The seventeenth condition is, for example, a condition in which the predetermined near-miss state has occurred. When the seventeenth condition is satisfied, the image data control apparatus 1 transitions the operation mode from the pseudo-off mode to the active mode. The seventeenth condition is an example of a condition under which the image data control apparatus 1 forcibly or automatically performs switching of the operation mode from the pseudo-off mode to the active mode.

The eighteenth condition is, for example, a condition in which a collision against the vehicle has occurred. When the eighteenth condition is satisfied, the image data control apparatus 1 transitions the operation mode from the pseudo-off mode to the active mode. The eighteenth condition is also an example of a condition under which the image data control apparatus 1 forcibly or automatically performs switching of the operation mode from the pseudo-off mode to the active mode.

The nineteenth condition is, for example, a condition in which the predetermined setting has been made for at least one of the predetermined functions installed in the vehicle. When the nineteenth condition is satisfied, the image data control apparatus 1 transitions the operation mode from the pseudo-off mode to the active mode. The nineteenth condition is also an example of a condition under which the image data control apparatus 1 forcibly or automatically performs switching of the operation mode from the pseudo-off mode to the active mode.

Note that the nineteenth condition may be configured to include human-initiated switching of the operation mode from the pseudo-off mode to the active mode in response to direct operation by the driver or the one or more occupants, or to remote operation by the fleet operator. The nineteenth condition may be configured to encompass both cases: human-initiated mode switching and forced or automatic mode switching by the image data control apparatus 1.

In addition to the eleventh and twelfth conditions for transitioning the operation mode of the image data control apparatus 1 from the active mode to the pseudo-off mode, a twentieth condition is further provided.

The twentieth condition is a condition that the predetermined time has elapsed in a case where the operation mode has been forcibly or automatically transitioned from the pseudo-off mode to the active mode based on satisfaction of at least one of the above-described seventeenth and eighteenth conditions. When the twentieth condition is satisfied, the image data control apparatus 1 transitions the operation mode from the active mode to the pseudo-off mode. The twentieth condition is an example of a condition under which the image data control apparatus 1 forcibly or automatically performs switching of the operation mode from the active mode to the pseudo-off mode.

The twentieth condition enables, when the operation mode has been switched from the pseudo-off mode to the active mode in response to occurrence of a near-miss state or a collision against the vehicle, the operation mode to be automatically returned from the active mode to the pseudo-off mode after the lapse of the predetermined time. This prevents continuation of the active mode even though the transient near-miss or collision state has already been resolved.

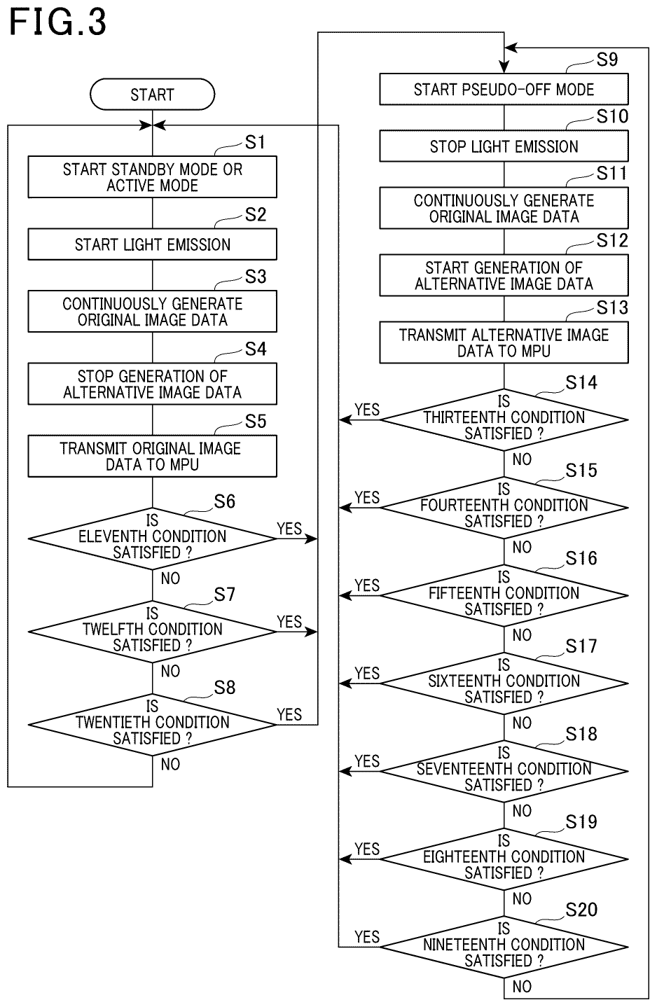

FIG. 3 illustrates an example of a control routine executed by the image data control apparatus 1. The following describes an example of the control routine in a state where the operation mode of the image data control apparatus 1 has been switched to the standby mode or the active mode.

When starting the standby mode or the active mode in step S1, the image data control apparatus 1 performs control operations defined by the standby mode or the active mode, thus instructing the illumination unit 14 to emit light in step S2. Additionally, the image data control apparatus 1 instructs the imager 11 to continuously generate original image data in step S3. In step S4, the image data control apparatus 1 instructs the alternative image data generation processor 43 to stop generation of alternative image data. In step S5, the image data control apparatus 1 transmits the original image data generated by the imager 11 to the MPU 21.

The image data control apparatus 1 may instruct the imager 11 and the illumination unit 14 to execute an image-data generation operation in step S3 and execute a light emitting operation in step S2 in synchronization with one another or asynchronously with one another. That is, the image data control apparatus 1 may instruct illumination unit 14 to emit light in accordance with the clock of the imaging process by the imager 11, or may perform illumination without conforming to that clock. That is, the image data control apparatus 1 may instruct the illumination unit 14 to perform the emitting of light in synchronization with the imaging clock of the imager 11 or instruct the illumination unit 14 to perform the emitting of light asynchronously with the imaging clock of the imager 11. The image data control unit 1 may instruct the illumination unit 14 to continuously perform the emitting of light asynchronously with the imaging clock of the imager 11.

The image data control apparatus 1 monitors whether any one of the predetermined conditions for switching the operation mode from the standby mode or the active mode to the pseudo-off mode, that is, any one of the above-described eleventh, twelfth, and twentieth conditions, is satisfied in steps S6, S7, and S8.

In response to determination that none of the eleventh, twelfth, and twentieth conditions is satisfied (NO in each of steps S6, S7, and S8), the control routine returns to step S1. Alternatively, in response to determination that none of the eleventh, twelfth, and twentieth conditions is satisfied (NO in each of steps S6, S7, and S8), the control routine may proceed to any one of steps S2 to S5.

Otherwise, in response to determination that any one of the eleventh, twelfth, and twentieth conditions is satisfied (YES in a corresponding one of steps S6, S7, and S8), the image data control apparatus 1 determines that no transmission of the original image data generated by the imager 11 to the MPU 21 has been set. Then, the image data control apparatus 1 terminates the executing operation mode, i.e., the standby mode or the active mode, and sets the operation mode to the pseudo-off mode and performs control operates defined by the pseudo-off mode in step S9.

As described above, the twentieth condition is a condition for transitioning the operation mode from the active mode to the pseudo-off mode. Therefore, when the image data control apparatus 1 has started the standby mode in step S1, the image data control apparatus 1 may be configured not to execute the operation in step S8, i.e., the operation of determining satisfaction of the twentieth condition.

When starting the control operations defined by the pseudo-off mode in step S9, the image data control apparatus 1 instructs the illumination unit 14 to stop the emitting of light in step S10, and instructs the imager 11 to continue generation of original image data in step S11. That is, the image data control apparatus 1 instructs the imager 11 to continue generation of original image data not only in each of the standby and active modes but also in the pseudo-off mode.

In particular, in the pseudo-off mode, the image data control apparatus 1 instructs the alternative image data generation processor 43 to start generation of alternative image data in step S12, and instructs the alternative image data generation processor 43 to transmit, to the MPU 21, the alternative image data generated by the processor 43 in place of the original image data generated by the imager 11 in step S13.

The image data control apparatus 1 monitors whether any one of the predetermined conditions for switching the operation mode from the pseudo-off mode to the standby mode or the active mode to the standby mode or the active mode, that is, any one of the above-described thirteenth to nineteenth conditions, is satisfied in steps S14 to S20.

In response to determination that none of the thirteenth to nineteenth conditions is satisfied (NO in each of steps S14 to S20), the control routine returns to step S9. Alternatively, in response to determination that none of those conditions is satisfied, the control routine may proceed to any one of steps S10 to S13.

Otherwise, in response to determination that any one of the thirteenth to nineteenth conditions is satisfied (YES in a corresponding one of steps S14 to S20), the image data control apparatus 1 determines that transmission of the original image data generated by the imager 11 to the MPU 21 has been set. Then, the image data control apparatus 1 terminates the executing pseudo-off mode, and sets the operation mode to the standby mode or the active mode and performs the control operates defined by the standby mode or the active mode in step S1.

In response to determination that the thirteenth or fourteenth condition is satisfied (YES in step S14 or S15), the image data control apparatus 1 starts the control operations defined by the standby mode in step S1. Otherwise, in response to determination that any one of the fifteenth to nineteenth conditions is satisfied (YES in any one of steps S16 to S20), the image data control apparatus 1 starts the control operations defined by the active mode in step S1.

The image data control apparatus 1 continuously executes the above-described control routine, for example, from when the ignition switch of the vehicle is turned on until the ignition switch is turned off.

Alternatively, the image data control apparatus 1 may start the control operations defined by the pseudo-off mode as a default mode immediately after the ignition switch is turned on, then transition the operation mode from the pseudo-off mode to the standby mode or the active mode when the corresponding predetermined condition is satisfied, and thereafter maintain the standby mode or the active mode until the ignition switch is turned off.

The determination processor 41 of the image data control apparatus 1 according to the example configuration, i.e., the first embodiment, of the present disclosure determines whether to request transmission of original image data to the MPU 21. When the determination processor 41 determines to request transmission of original image data to the MPU 21, that is, determines transmission of original image data being permitted, the transmission processor 42 instructs the imager 11 to transmit the original image data generated by the imager 11 to the MPU 21 without being changed.

In contrast, when the determination processor 41 determines not to request transmission of original image data to the MPU 21, that is, determines transmission of original image data not being permitted, the transmission processor 42 instructs the alternative image data generation processor 43 to generate alternative image data and transmit, to the MPU 21, the generated alternative image data in place of the original image data generated by the imager 11.

This configuration of the image data control apparatus 1 makes it possible to avoid the original image data generated by the imager 11 from being processed by the MPU 21 when the operation mode of the image data control apparatus 1 is set to the pseudo-off mode without stopping the image-data generation operation by the imager 11. This therefore prevents excessive processing of original image data reflecting the in-cabin situation of the vehicle, thus ensuring sufficient privacy protection.

Even if the operation mode of the image data control apparatus 1 according to the first embodiment is set to the pseudo-off mode, the imager 11, the in-vehicle camera 11C, the serializer 12, the deserializer 22, and the MPU 21 are maintained in the on state without being turned off. This configuration therefore enables, upon the operation mode of the image data control apparatus 1 being switched from the pseudo-off mode to the active mode, the apparatus 1 to instruct the imager 11 to restart generation of in-cabin image data, i.e., in-cabin image capturing task, immediately.

The image data control apparatus 1 according to the first embodiment includes the alternative image data generation processor 43, which generates alternative image data, as an independent component in place of a part of other components. This enables the alternative image data generation processor 43 to focus on generating alternative image data, making it possible to perform generation of alternative image data more reliably and more immediately. The alternative image data generation processor 43 may, for example, be provided as a circuit independently of components, such as the imager 11, the serializer 12, the deserializer 22, and the MPU 21, in place of being provided as part of the imager 11. This therefore makes it possible to enhance the independence of the alternative image data generation processor 43.

The alternative image data generation processor 43 of the image data control apparatus 1 according to the first embodiment is provided in the imager 11. This configuration enables alternative image data generated by the alternative image data generation processor 43 to be transmitted from the imager 11 that generates the original image data. Although the independence of the alternative image data generation processor 43 is slightly reduced, this configuration makes it possible to more reliably prevent the original image data from being erroneously transmitted from the imager 11 upon the original image data being determined not to be transmitted from the imager 11.

The illumination unit 14 of the image data control apparatus 1 according to the first embodiment is configured to emit light to increase the received light quantity of the in-vehicle camera 11C that cooperates with the imager 11. This configuration results in clearer original image data to be generated and transmitted to the MPU 21.

The illumination unit 14 is configured to emit light when the determination processor 41 determines to request transmission of original image data to the MPU 21, and not to emit light when the determination processor 41 determines not to request transmission of original image data to the MPU 21.

This configuration enables a user to visually and easily confirm, based on the presence or absence of light emission from the illumination unit 14, whether original image data is being transmitted from the imager 11 to the MPU 21.

Alternatively, the illumination unit 14 may be configured not to emit light when the determination processor 41 determines to request transmission of original image data to the MPU 21, and configured to emit light when the determination processor 41 determines not to request transmission of original image data to the MPU 21. This modified configuration enables, although it becomes difficult to increase the quantity of received light of the in-vehicle camera 11C that cooperates with the imager 11, a user to visually recognize, based on the presence or absence of light emission from the illumination unit 14, whether original image data is being transmitted from the imager 11 to the MPU 21.

The illumination unit 14 may be configured to vary an emission mode of light to be emitted therefrom depending on whether the determination processor 41 determines to request transmission of original image data to the MPU 21. This configuration additionally enables a user to visually recognize, based on differences in the emission mode of the illumination unit 14, whether original image data is being transmitted from the imager 11 to the MPU 21. Examples of the emission mode of the illumination unit 14 include continuous emission of light, intermittent emission of light, variation in intensity of light, variation in color of light, and variation in wavelength of light.

The image data control apparatus 1 may be configured to execute the image-data generation task by the imager 11 and the alternative image generation task by the alternative image data generation processor 43 in synchronization with each other, or to execute those tasks without synchronization.

### Second Embodiment

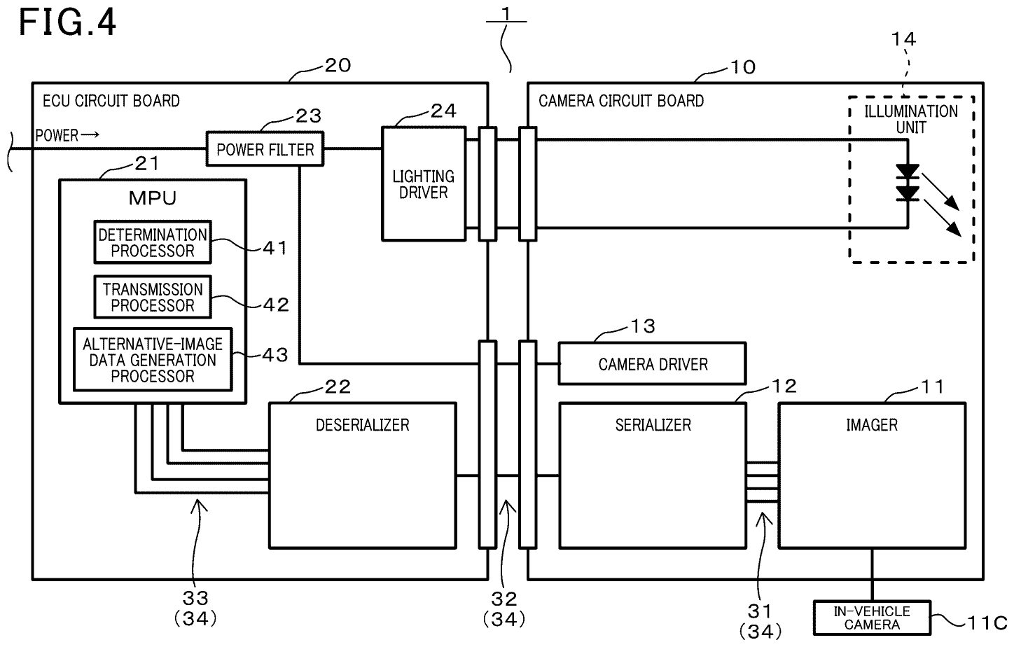

An image data control apparatus 1 illustrated as an example in FIG. 4 is configured such that the alternative image data generation processor 43 is provided in the MPU 21 in place of the imager 11. This configuration causes original image data generated by the imager 11 to be transmitted to the MPU 21 when the determination processor 41 determines to request transmission of original image data to the MPU 21.

When the determination processor 41 determines to request transmission of original image data to the MPU 21, that is, determines transmission of original image data being permitted, the MPU 21 is configured to process the original image data transmitted from the imager 11.

In contrast, when the determination processor 41 determines not to request transmission of original image data to the MPU 21, that is, determines transmission of original image data not being permitted, the MPU 21 is configured to process alternative image data generated by the alternative image data generation processor 43 in place of original image data generated by the imager 11.

This configuration of the image data control apparatus 1 according to the second embodiment makes it possible to avoid the original image data generated by the imager 11 from being processed by the MPU 21 without stopping the image-data generation operation by the imager 11. This therefore prevents excessive processing of original image data reflecting the in-cabin situation of the vehicle, thus ensuring sufficient privacy protection.

In the image data control apparatus 1 according to the second embodiment, at least one of the imager 11, the in-vehicle camera 11C, the serializer 12, the deserializer 22, and the MPU 21 may be switched from the on state to the off state from the on state. In this modification, components whose power-up time from the off state to the on state is relatively short and whose impact on the time until the image-data generation operation, i.e., image capturing operation, starts is relatively small may be preferentially switched from the on state to the off state. This modified configuration makes it possible to shorten the time required to start the image capturing operation after it has been stopped and reduce power consumption of the image data control apparatus 1 due to turn-off of at least one of the imager 11, the in-vehicle camera 11C, the serializer 12, the deserializer 22, and the MPU 21.

### Third Embodiment

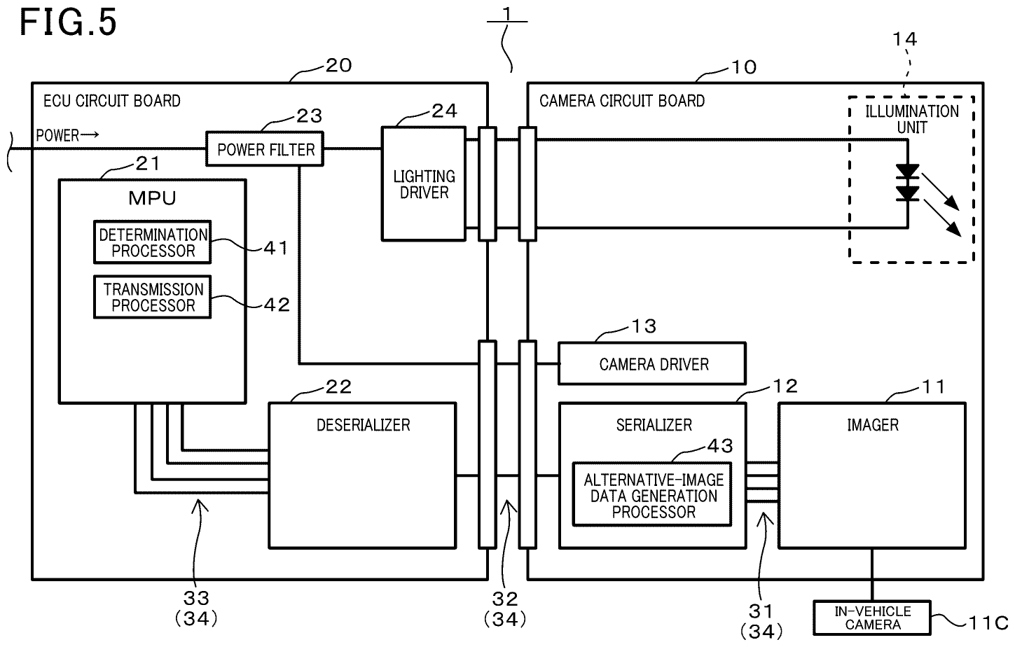

An image data control apparatus 1 illustrated as an example in FIG. 5 is configured such that the alternative image data generation processor 43 is provided in the serializer 12 in place of the imager 11 or the MPU 21; the serializer 12 is provided in the at least one transmission path 34 located between the imager 11 and the MPU 21. This configuration causes original image data generated by the imager 11 to be transmitted to the serializer 12 even if the determination processor 41 determines not to request transmission of original image data to the MPU 21.

When the determination processor 41 determines to request transmission of original image data to the MPU 21, that is, determines transmission of original image data being permitted, the serializer 12 is configured to directly transmit, to the MPU 21, the original image data transmitted from the imager 11.

In contrast, when the determination processor 41 determines not to request transmission of original image data to the MPU 21, that is, determines transmission of original image data not being permitted, the serializer 12 is configured to transmit, to the MPU 21, alternative image data generated by the alternative image data generation processor 43 in place of original image data transmitted from the imager 11. This configuration enables the serializer 12 to recognize, based on a signal transmitted from the MPU 21 through the at least one transmission path 34.

When the original image data is transmitted from the serializer 21, the MPU 21 is configured to process the original image data. In contrast, when the alternative image data is transmitted from the serializer 21, the MPU 21 is configured to process the alternative image data.

This configuration of the image data control apparatus 1 according to the third embodiment makes it possible to avoid the original image data generated by the imager 11 from being processed by the MPU 21 without stopping the image-data generation operation by the imager 11. This therefore prevents excessive processing of original image data reflecting the in-cabin situation of the vehicle, thus ensuring sufficient privacy protection.

In the image data control apparatus 1 according to the third embodiment, at least one of the imager 11 and the in-vehicle camera 11C may be switched from the on state to the off state from the on state. In this modification, components whose power-up time from the off state to the on state is relatively short and whose impact on the time until the image-data generation operation, i.e., image capturing operation, starts is relatively small may be preferentially switched from the on state to the off state. This modified configuration makes it possible to shorten the time required to start the image capturing operation after it has been stopped and reduce power consumption of the image data control apparatus 1 due to turn-off of at least one of the imager 11 and the in-vehicle camera 11C.

The image data control apparatus 1 of the third embodiment may be modified such that the alternative image data generation processor 43 is provided in the deserializer 34 mounted in the at least one transmission path 34 located between the imager 11 and the MPU 21. Alternatively, the image data control apparatus 1 of the third embodiment may be modified such that the alternative image data generation processor 43 is provided as an independent component from the serializer 34 and the deserializer 34 between the imager 11 and the MPU 21.

### Fourth Embodiment

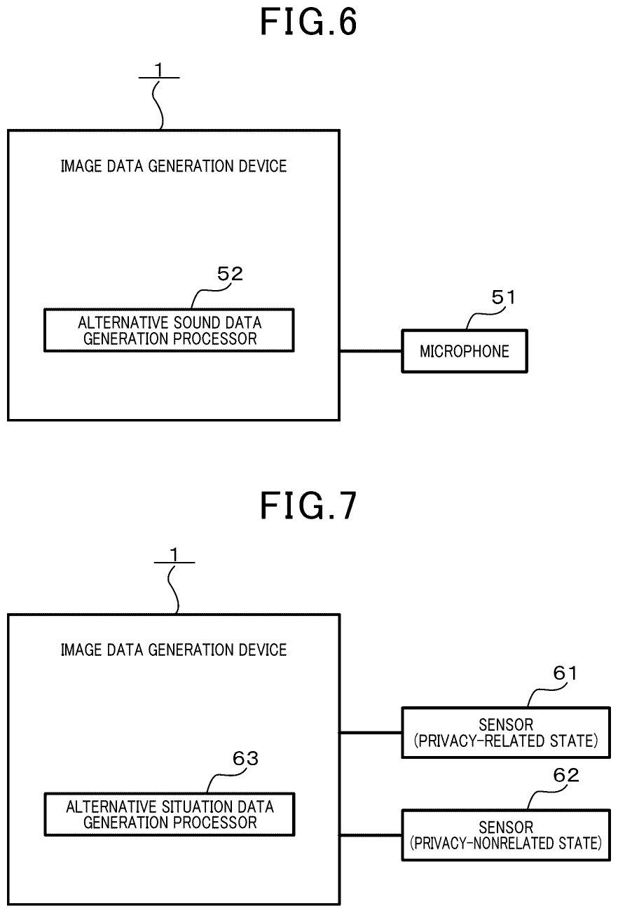

An image data control apparatus 1 according to the fourth embodiment illustrated as an example in FIG. 6 additionally includes a microphone 51. The microphone 51 is an example of an audio data generator, and is configured to generate, when receiving sounds, original audio data based on the received sounds. The microphone 51 is arranged to collect sounds generated in the vehicle cabin. The MPU 21 of the fourth embodiment is additionally configured to process the audio data generated from the microphone 51. The determination processor 41 additionally determines whether to request transmission of audio data to the MPU 21. The transmission processor 42 additionally instructs the microphone 51 to transmit the audio data generated thereby to the MPU 21 when the determination processor 41 determines to request transmission of audio data to the MPU 21. In FIG. 6, illustration of the imager 11, the serializer 12, the MPU 21, the deserializer 22, the determination processor 41, and the transmission processor 42 is omitted.

When the determination processor 41 determines to request transmission of original audio data to the MPU 21, that is, determines transmission of original audio data being permitted, the transmission processor 42 instructs the microphone 51 to transmit the original audio data generated by the microphone 51 to the MPU 21 without being changed.

The image data control apparatus 1 of the fourth embodiment additionally includes an alternative audio data generation processor 52 for generating alternative audio data. The alternative audio data generation processor 52 serves as an example of an alternative audio data generator. The alternative audio data generation processor 52 may be installed in any one of the MPU 21 and the microphone 51. Alternatively, the alternative audio data generation processor 52 may be provided as an independent component from the MPU 21 and the microphone 51 in a transmission path defined between the microphone 51 and the MPU 21. The alternative audio data generation processor 52 may be implemented as software or a combination of hardware and software.

The alternative audio data generation processor 52 may for example generate, as the alternative audio data, silence data or predetermined sound data. That is, the alternative audio data generation processor 52 is configured to generate, as the alternative audio data, any audio data that is different from original sound data reflecting sounds generated in the vehicle cabin.

Original image data generated by the imager 11 denotes visual information reflecting the condition in the vehicle cabin. Original audio data generated by the microphone 51 denotes auditory information reflecting the condition in the vehicle cabin. Each of the original image data generated by the imager 11 and the original audio data generated by the microphone 51 shows information that may infringe on driver's privacy and/or occupant's privacy.

This configuration of the image data control apparatus 1 according to the fourth embodiment makes it possible to avoid
(I) The original image data generated by the imager 11 from being processed by the MPU 21 without stopping the image-data generation operation by the imager 11, and
(II) The original audio data generated by the microphone 51 from being processed by the MPU 21 without stopping the audio-data generation operation by the microphone 51.

This therefore prevents excessive processing of original image data and original audio data reflecting the in-cabin situation of the vehicle, thus ensuring sufficient visual and auditory privacy protection.

### Fifth Embodiment

An image data control apparatus 1 according to the fifth embodiment illustrated as an example in FIG. 7 additionally includes sensors 61 and 62. Each of the sensors 61 and 62 is an example of a situation data generator, and is configured to generate situation data indicating the situation in the vehicle cabin.

The sensor 61 is for example configured to generate first situation data indicating situations directly related to human privacy, such as a driver's or occupant's pulse, heart rate, or body temperature.

The sensor 62 is for example configured to generate second situation data indicating situations not directly related to human privacy, such as the temperature, humidity, carbon dioxide concentration, or illuminance in the vehicle cabin. Note that the second situation data detected by the sensor 62 may nevertheless become situation data indirectly related to human privacy.

The MPU 21 of the image data control apparatus 1 is further configured to process each of the first situation data generated by the sensor 61 and the second situation data generated by the sensor 62. The determination processor 41 is further configured to determine whether to request transmission of the first and second situation data to the MPU 21. The transmission processor 42 is further configured to instruct each of the sensors 61 and 62 to transmit the corresponding one of the first situation data and the second situation data generated thereby to the MPU 21. Note that, in FIG. 7, components such as the imager 11, the serializer 12, the MPU 21, the deserializer 22, the determination processor 41, and the transmission processor 42 are omitted for simpler illustration.

When the determination processor 41 determines to request transmission of the first and second situation data to the MPU 21, that is, determines transmission of the first situation data and the second situation data being permitted, the transmission processor 42 instructs each of the sensors 61 and 62 to transmit the corresponding one of the first situation data and the second situation data generated thereby to the MPU 21 without being changed.

In contrast, when the determination processor 41 determines not to request transmission of the first and second situation data to the MPU 21, that is, determines transmission of the first and second situation data not being permitted, the transmission processor 42 is configured to execute an alternative situation data transmission task.

Specifically, the image data control apparatus 1 of the fifth embodiment additionally includes an alternative situation data generation processor 63 for generating alternative situation data. The alternative situation data generation processor 63 serves as an example of an alternative situation data generator. The alternative situation data generation processor 63 may be installed in any one of the MPU 21 and the sensor 61. Alternatively, the alternative situation data generation processor 63 may be provided as an independent component from the MPU 21 and the sensors 61 and 62 in a transmission path defined between each sensor 61, 62 and the MPU 21. The alternative situation data generation processor 63 may be implemented as software or a combination of hardware and software.

The alternative situation data generation processor 63 may for example generate, as the alternative situation data, meaningless dummy data. That is, the alternative situation data generation processor 63 is configured to generate, as the alternative situation data, any situation data that is different from original situation data directly or indirectly reflecting the privacy of the one or more occupants in the vehicle cabin.

Original first situation data generated by the sensor 61 include information directly related to human privacy and thus are highly likely to infringe the privacy of the driver or the one or more occupants of the vehicle. Although original second situation data generated by the sensor 62 do not directly relate to human privacy, they may, in some cases, still cause a risk of infringing the privacy of the driver or the one or more occupants.

This configuration of the image data control apparatus 1 according to the fifth embodiment makes it possible to avoid
(I) The original image data generated by the imager 11 from being processed by the MPU 21 without stopping the image-data generation operation by the imager 11, and
(II) The original first situation data and the second situation data generated by the sensors 61 and 62 from being processed by the MPU 21 without stopping the situation data generation operation by each of the sensors 61 and 62.

Accordingly, this configuration makes it possible achieve privacy protection not only from a visual standpoint, but also from physiological and environmental standpoints—for example, with respect to biometric information such as pulse, heart rate, and body temperature of the driver or the one or more occupants, and environmental information such as temperature, humidity, carbon dioxide concentration, and illuminance in the vehicle cabin.

The alternative situation data generation processor 63 may be configured to generate the alternative situation data only for the first situation data generated by the sensor 61, which are directly related to human privacy, and not to generate the alternative situation data for the second situation data generated by the sensor 62, which are not directly related to human privacy.

### Sixth Embodiment

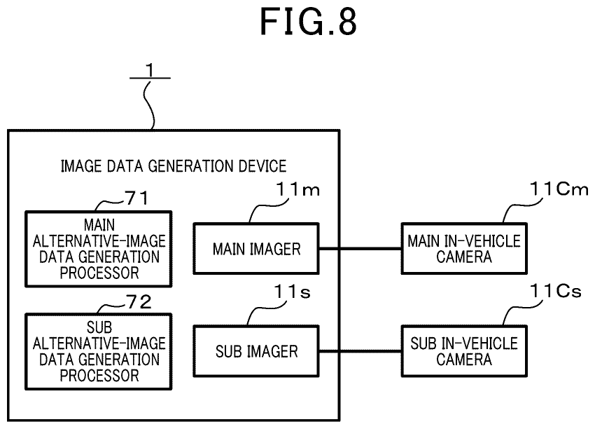

An image data control apparatus 1 according to the sixth embodiment illustrated as an example in FIG. 8 includes a main imager 11m and a sub imager 11s. The main imager 11m, which serves as an example of a main image data generator, generates, in collaboration with a main in-vehicle camera 11Cm, main image data using external light received thereby. the sub imager 11s, which serves as an example of a sub image data generator, generates, in collaboration with a sub in-vehicle camera 11Cs, sub image data using external light received thereby.

The main in-vehicle camera 11Cm is, for example, a camera arranged to capture the front portion of the vehicle cabin, such as the driver's seat and the passenger seat. The sub in-vehicle camera 11Cs is, for example, a camera arranged to capture the rear portion of the vehicle cabin, such as the rear seats. When the determination processor 41 determines to request transmission of the main image data to the MPU 21, that is, determines transmission of the main image data being permitted, the transmission processor 42 instructs each of the main imager 11m and the sub imager 11s to transmit the corresponding one of the main image data and the sub image data generated thereby to the MPU 21 without being changed.

In contrast, when the determination processor 41 determines not to request transmission of the main image data to the MPU 21, that is, determines transmission of the main image data not being permitted, the transmission processor 42 is configured to execute a main alternative image data transmission task and a sub alternative image data transmission task.

Specifically, the image data control apparatus 1 of the sixth embodiment additionally includes a main alternative image data generation processor 71 for generating main alternative image data, and a sub alternative image data generation processor 72 for generating sub alternative image data.

The main alternative image data generation processor 71 may be installed in any one of the main imager 11m, the serializer 12, the MPU 21, and the deserializer 22. Alternatively, the main alternative image data generation processor 71 may be provided as an independent component from main imager 11m, the serializer 12, the MPU 21, and the deserializer 22.

The sub alternative image data generation processor 72 may be installed in any one of the main imager 11m, the serializer 12, the MPU 21, and the deserializer 22. Alternatively, the sub alternative image data generation processor 72 may be provided as an independent component from main imager 11m, the serializer 12, the MPU 21, and the deserializer 22.

Each of the main alternative image data generation processor 71 and the sub alternative image data generation processor 72 may be implemented as software or a combination of hardware and software.

Each of the main alternative image data generated by the main alternative image data generation processor 71 and the sub alternative image data generated by the sub alternative image data generation processor 72 may be full-black image data consisting of zero-value pixels, predetermined solid-color image data consisting of pixels of a predetermined color, predetermined patterned image data consisting of pixels of a predetermined pattern, such as vertical stripes and/or horizontal stripes, or test-pattern image data consisting of pixels of a predetermined test pattern used for testing various devices. That is, the main alternative image data generated by the main alternative image data generation processor 71 may be any image data that is different from original main image data reflecting the condition in the vehicle cabin. Similarly, the sub alternative image data generated by the sub alternative image data generation processor 72 may be any image data that is different from original sub image data reflecting the condition in the vehicle cabin.

The main alternative image data and the sub alternative image data may be identical to one another or different from one another. For example, the image data control apparatus 1 may be configured to generate the main alternative image data which is black image data whose entire pixels show black, and generate the sub alternative image data which is pattern image data whose entire pixels have a prescribed pattern.

The image data control apparatus 1 of the sixth embodiment is configured such that, when the main imager 11m is instructed to transmit main image data therefrom to the MPU 21, the sub imager 11s is instructed to transmit sub image data therefrom to the MPU 21.

Similarly, the image data control apparatus 1 of the sixth embodiment is configured such that, when the main imager 11m is instructed to transmit main alternative image data therefrom to the MPU 21, the sub imager 11s is instructed to transmit sub alternative image data therefrom to the MPU 21.

Assuming that the in-vehicle cameras 11Cm and 11Cs are installed in the vehicle, the above configuration of the image data control apparatus 1 makes it possible to control the image capturing operations of one of the in-vehicle cameras 11Cm and 11Cs in synchronization with the image capturing operations of the other thereof. For example, the above configuration of the image data control apparatus 1 makes it possible to control the image capturing operations of the sub in-vehicle camera 11Cs in synchronization with the image capturing operations of the main in-vehicle camera 11Cm.

Thus, for example, even if the main alternative image data are being transmitted from the main in-vehicle camera 11Cm, it is possible to avoid a situation in which the other in-vehicle camera 11Cs continues to transmit actual in-cabin image data, making it possible to ensure even more robust privacy protection.

The number of in-vehicle cameras installed in the vehicle is not limited to two and may be three or more. The multiple in-vehicle cameras need not have a main-sub relationship; all in-vehicle cameras may instead have an equal relationship. In such a modification, when one of the multiple in-vehicle cameras is switched to a mode for transmitting alternative image data, the other cameras may all be forcibly switched to the same mode, thereby providing enhanced privacy protection.

### Seventh Embodiment

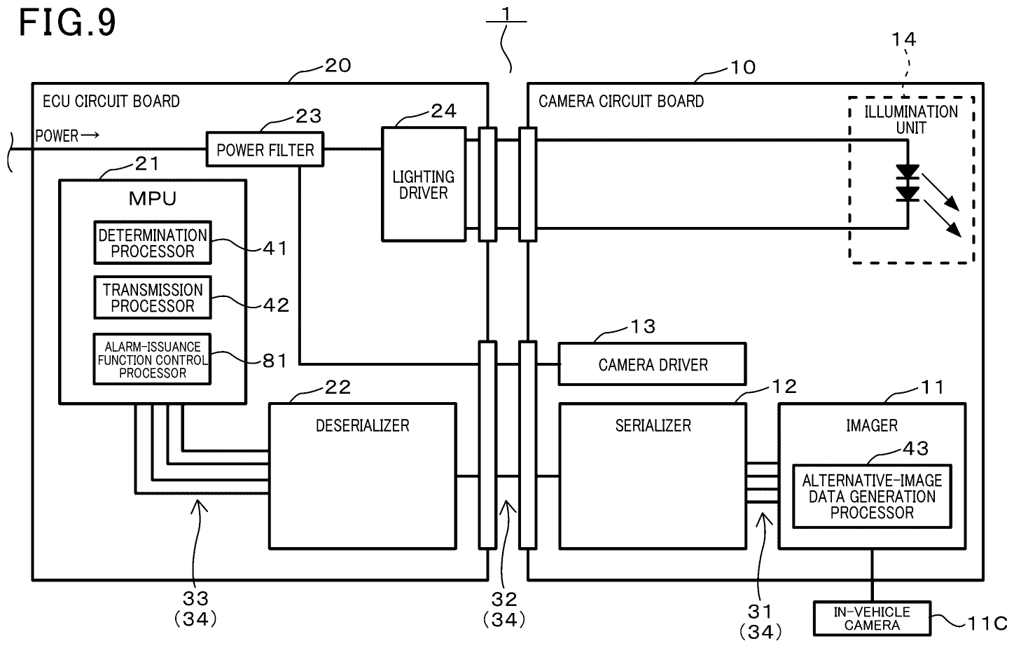

An image data control apparatus 1 according to the seventh embodiment illustrated as an example in FIG. 9 includes an alarm-function control processor 81, which is an example of an alarm-function controller, and is configured to control switching between the on state and the off state of an alarm issuing function provided in the image data control apparatus 1. The alarm-function control processor 81 according to the present disclosure is provided in the MPU 21. The alarm-function control processor 81 may be implemented by software, by hardware, or by a combination of software and hardware. When the MPU 21 receives alternative image data, the alarm-function control processor 81 is configured to switch the alarm issuing function from the on state to the off state.

A signal for switching the alarm issuing function from the on state to the off state may be embedded in a portion of the alternative image data. For example, the portion of the alternative image data in which the signal is embedded may be a luminance information storage portion located in the first pixel-row of the alternative image data or a header portion of the alternative image data, or another region of the alternative image data. The alarm-function control processor 81 may be configured to analyze the alternative image data received by the MPU 21 and, when a predetermined condition is satisfied based on the analysis result, switch the alarm issuing function from the on state to the off state. The predetermined condition may be, for example, that the number of pixels with zero luminance, obtained by known histogram analysis of the alternative image data, is greater than or equal to a threshold value.

The image data control apparatus 1 according to the seventh embodiment is configured to switch the on/off state of the alarm issuing function using the alternative image data, making it possible to eliminate the need to newly provide a configuration for data communication dedicated to switching the alarm issuing function. This therefore simplifies both the software and hardware configurations relating to data communication.

### Other Embodiments and Modifications

The present disclosure is not limited to the above-described embodiments. Various modifications and extensions may be made without departing from the scope of the present disclosure. For example, the image data control apparatus 1 may have a configuration in which appropriate ones of the above-described multiple embodiments are selectively combined.

The image data control apparatus 1 may have a configuration in which the imager 11, the MPU 21, and other components are mounted on a single common board. In this modification, the serializer 12 and the deserializer 22 may be omitted.

The conditions for transitioning the operation mode from the standby mode or the active mode to the pseudo-off mode may include an additional condition in which an instruction for switching the operation mode from the standby mode or the active mode to the pseudo-off mode is input using a predetermined application. The predetermined application may, for example, be installed in a terminal that is communicably connected to the image data control apparatus 1.

The conditions for transitioning the operation mode from the standby mode or the active mode to the pseudo-off mode may include an additional condition in which a warning notification that prompts operation-mode switching from the standby mode or the active mode to the pseudo-off mode is received from a warning system communicably connected to the image data control apparatus 1. Other conditions for transitioning the operation mode from the standby mode or the active mode to the pseudo-off mode may be additionally set.

The conditions for transitioning the operation mode from the pseudo-off mode to the standby mode or the active mode may include a condition in which an instruction for switching the operation mode from the pseudo-off mode to the standby mode or the active mode is input using a predetermined application.

The conditions for transitioning the operation mode from the pseudo-off mode to the standby mode or the active mode may include an additional condition in which a warning notification that prompts operation-mode switching from the pseudo-off mode to the standby mode or the active mode is received from a warning system communicably connected to the image data control apparatus 1. Other conditions for transitioning the operation mode from the pseudo-off mode to the standby mode or the active mode may be additionally set.

It is desirable that the image data control apparatus 1 be provided with a means for notifying a user, for example, before use of the apparatus 1, that the operation mode of the image data control apparatus 1 may be forcibly transitioned under certain circumstances.

The in-vehicle cameras 11C, 11Cm, and 11Cs may be cameras that receive light other than near-infrared light. The illumination unit 14 may also be configured to emit light other than near-infrared light.

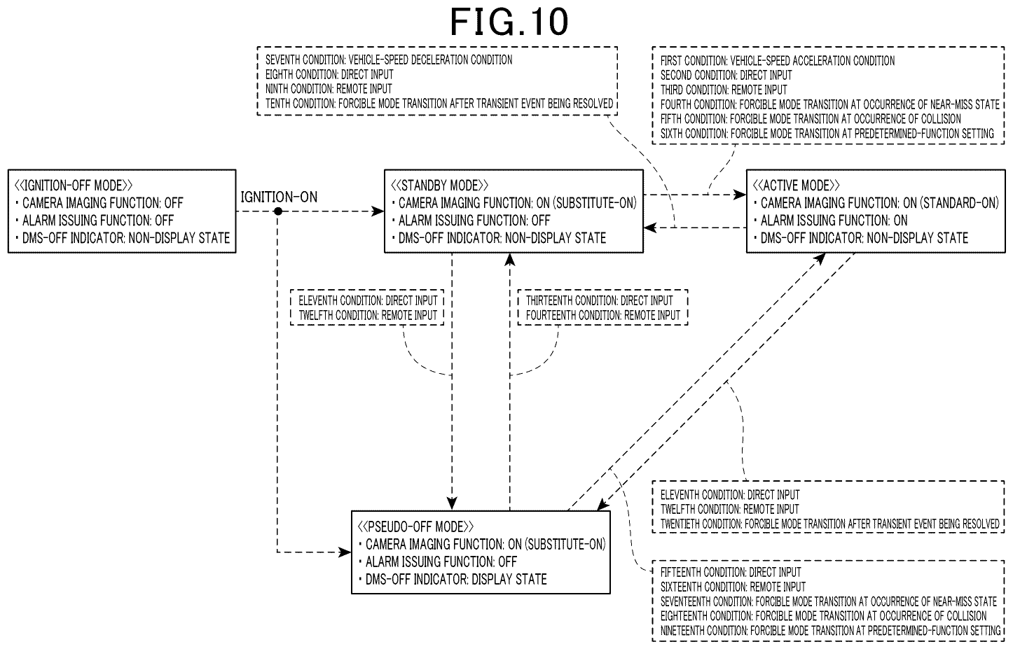

As illustrated in FIG. 10, the image data control apparatus 1 may be configured such that, in the standby mode, the camera imaging function is set to be in the substitute-on state rather than the standard-on state. This modification enables the camera imaging function to be maintained in the same substitute-on mode in both the standby mode and the pseudo-off mode. This makes it possible to simplify the system configuration compared to a configuration in which the camera imaging function is set to different states between the standby mode and the pseudo-off mode.

Although the present disclosure has been described in accordance with the above embodiments, it is to be understood that the present disclosure is not limited to those embodiments or configurations. The present disclosure also encompasses various modifications and equivalents within the scope of the inventive concept. Furthermore, various combinations and forms, which include those having only one element of the above, more than one, or fewer than those, are also included within the scope of the present disclosure.

The control apparatuses 1 and their control methods according to the present disclosure can be implemented by a dedicated computer including a memory and a processor programmed to perform one or more functions embodied by one or more computer programs.

The control apparatuses 1 and their control methods according to the present disclosure can also be implemented by a dedicated computer including a processor comprised of one or more dedicated hardware logic circuits.

The control apparatuses 1 and their control methods according to the present disclosure can further be implemented by a processor system comprised of a memory, a processor programmed to perform one or more functions embodied by one or more computer programs, and one or more hardware logic circuits.

The one or more programs can be stored in a computer-readable non-transitory storage medium as instructions to be carried out by a computer or a processor.

The present disclosure includes, in addition to features described in CLAIMS, the following features:

### [First Feature]

A first feature of the present disclosure provides an image data control apparatus. The image data control apparatus includes an image data generator (11) configured to generate image data using external light received thereby, and a processing unit (21) configured to process the image data. The image data control apparatus includes a determiner (41) configured to determine whether to request transmission of the image data to the processing unit, and a transmitter (42) configured to transmit the image data to the processing unit.

The transmitter is configured to transmit the image data to the processing unit upon the determiner determining to request transmission of the image data to the processing unit, and transmit alternative image data in place of the image data to the processing unit upon the determiner determining not to request transmission of the image data to the processing unit.

### [Second Feature]

The image data control apparatus of a second feature of the present disclosure, which depends from the first feature, further includes an alternative image data generator (43) configured to generate the alternative image data.

### [Third Feature]

In a third feature of the present disclosure, which depends from the second feature, the alternative image data generator is installed in the image data generator.

### [Fourth Feature]

In a fourth feature of the present disclosure, which depends from the second feature, the alternative image data generator is installed in the processing unit.

### [Fifth Feature]

In a fifth feature of the present disclosure, which depends from the second feature, the alternative image data generator is provided between the image data generator and the processing unit.

### [Sixth Feature]

In a sixth feature of the present disclosure, which depends from the fifth feature, the image data is parallel image data, and the image data control apparatus further includes a converter (12) provided between the image data generator and the processing unit and configured to convert the parallel image data into serial image data. The alternative image data generator is installed in the converter.

### [Seventh Feature]

In a seventh feature of the present disclosure, which depends from any one of the first to sixth features, the processing unit includes an alarm issuing function, the alarm issuing function issuing a predetermined alarm upon the alarm issuing function being set to be in an on state. The processing unit is configured to set the alarm issuing function to be in an off state in response to receiving the alternative image data.

### [Eighth Feature]

In an eight feature of the present disclosure, which depends from any one of the first to seventh features, the transmitter is configured to switch at least one of the image data generator and the processing unit to be in an off state upon the determiner determining not to request transmission of the image data to the processing unit.

### [Ninth Feature]

The image data control apparatus of a ninth feature of the present disclosure, which depends from any one of the first to seventh features, further includes a light emitting unit (14) configured to perform light emission to increase a light quantity to be received by the image data generator. The light emitting unit is configured to emit light upon the determiner determining to request transmission of the image data to the processing unit, and the light emitting unit is configured not to emit light upon the determiner determining not to request transmission of the image data to the processing unit.

### [Tenth Feature]

The image data control apparatus of a tenth feature of the present disclosure, which depends from any one of the first to ninth features, further includes an audio data generator (51) configured to generate, when receiving a sound, audio data based on the received sound. The processing unit is configured to process the audio data. The determiner is configured to determine whether to request transmission of the audio data to the processing unit. The transmitter is configured to transmit the audio data to the processing unit upon the determiner determining to request transmission of the audio data to the processing unit, and transmit alternative audio data in place of the audio data to the processing unit upon the determiner determining not to request transmission of the audio data to the processing unit.

### [Eleventh Feature]

The image data control apparatus of an eleventh feature of the present disclosure, which depends from any one of the first to tenth features, further includes a situation data generator (61, 62) configured to generate situation data indicating a situation in a vehicle cabin. The processing unit is configured to process the situation data. The determiner is configured to determine whether to request transmission of the situation data to the processing unit. The transmitter is configured to transmit the situation data to the processing unit upon the determiner determining to request transmission of the situation data to the processing unit, and transmit alternative situation data in place of the situation data to the processing unit upon the determiner determining not to request transmission of the situation data to the processing unit.

### [Twelfth Feature]

In a twelfth feature of the present disclosure, which depends from any one of the first to eleventh features, the image data generator includes a main image data generator (11m) and a sub image data generator (11s). The main image data generator is configured to generate main image data as the image data, and the sub image data generator is configured to generate sub image data as the image data. The transmitter is configured to transmit each of the main image data and the sub image data to the processing unit upon the determiner determining to request transmission of the main image data to the processing unit, and transmit (i) alternative main image data in place of the main image data and (ii) alternative sub image data in place of the sub image data to the processing unit upon the determiner determining not to request transmission of the main image data to the processing unit.

1. An image data control apparatus comprising:
an image data generator configured to generate image data using external light received thereby;
a processing unit configured to process the image data;
a determiner configured to determine whether to request transmission of the image data to the processing unit; and
a transmitter configured to transmit the image data to the processing unit,
wherein:
the transmitter is configured to:
transmit the image data to the processing unit upon the determiner determining to request transmission of the image data to the processing unit;
transmit alternative image data in place of the image data to the processing unit upon the determiner determining not to request transmission of the image data to the processing unit; and
maintain the image data generator and the processing unit in an on state upon the determiner determining not to request transmission of the image data to the processing unit.

2. The image data control apparatus according to claim 1, further comprising:
an alternative image data generator configured to generate the alternative image data.

3. The image data control apparatus according to claim 2, wherein:
the alternative image data generator is installed in the image data generator.

4. The image data control apparatus according to claim 2, wherein:
the alternative image data generator is installed in the processing unit.

5. The image data control apparatus according to claim 2, wherein:
the alternative image data generator is provided between the image data generator and the processing unit.

6. The image data control apparatus according to claim 5, wherein:
the image data is parallel image data, the image data control apparatus further comprising:
a converter provided between the image data generator and the processing unit and configured to convert the parallel image data into serial image data,
the alternative image data generator is installed in the converter.

7. The image data control apparatus according to claim 1, wherein:
the processing unit includes an alarm issuing function, the alarm issuing function issuing a predetermined alarm upon the alarm issuing function being set to be in an on state; and
the processing unit is configured to set the alarm issuing function to be in an off state in response to receiving the alternative image data.

8. The image data control apparatus according to claim 1, further comprising:
a light emitting unit configured to perform light emission to increase a light quantity to be received by the image data generator, wherein:
the light emitting unit is configured to emit light upon the determiner determining to request transmission of the image data to the processing unit; and
the light emitting unit is configured not to emit light upon the determiner determining not to request transmission of the image data to the processing unit.

9. The image data control apparatus according to claim 1, further comprising:
an audio data generator configured to generate, when receiving a sound, audio data based on the received sound, wherein:
the processing unit is configured to process the audio data;
the determiner is configured to determine whether to request transmission of the audio data to the processing unit; and
the transmitter is configured to:
transmit the audio data to the processing unit upon the determiner determining to request transmission of the audio data to the processing unit; and
transmit alternative audio data in place of the audio data to the processing unit upon the determiner determining not to request transmission of the audio data to the processing unit.

10. The image data control apparatus according to claim 1, further comprising:
a situation data generator configured to generate situation data indicating a situation in a vehicle cabin, wherein:
the processing unit is configured to process the situation data;
the determiner is configured to determine whether to request transmission of the situation data to the processing unit; and
the transmitter is configured to:
transmit the situation data to the processing unit upon the determiner determining to request transmission of the situation data to the processing unit; and
transmit alternative situation data in place of the situation data to the processing unit upon the determiner determining not to request transmission of the situation data to the processing unit.

11. The image data control apparatus according to claim 1, wherein:
the image data generator comprises a main image data generator and a sub image data generator;
the main image data generator is configured to generate main image data as the image data;
the sub image data generator is configured to generate sub image data as the image data; and
the transmitter is configured to:
transmit each of the main image data and the sub image data to the processing unit upon the determiner determining to request transmission of the main image data to the processing unit; and
transmit (i) alternative main image data in place of the main image data and (ii) alternative sub image data in place of the sub image data to the processing unit upon the determiner determining not to request transmission of the main image data to the processing unit.
